(19) United States
(12) Patent Application Publication
(10) Pub. No.: US 2015/0213303 A1
(43) Pub. Date: Jul. 30, 2015

(54) IMAGE PROCESSING WITH FACIAL REFERENCE IMAGES

(71) Applicant: NVIDIA Corporation, Santa Clara, CA (US)

(72) Inventor: Amit Jain, Gurgaon (IN)

(73) Assignee: NVIDIA Corporation, Santa Clara, CA (US)

(21) Appl. No.: 14/166,652

(22) Filed: Jan. 28, 2014

(51) Int. Cl. G06K 9/00; H04N 13/02; H04N 5/235

(52) U.S. Cl. CPC G06K 9/00221; G06K 9/00255; H04N 5/2354; H04N 13/0246; H04N 13/0239; H04N 2213/003; H04N 2101/00

(57) ABSTRACT

Systems and methods are provided for capturing and processing digital images. During a capture session, an image capture system is configured to capture one or more subject images and one or more calibration images potentially containing the user's face under common lighting conditions. The subject images and the calibration images are captured using two differently-aimed cameras within a common enclosure. The one or more calibration images are compared to one or more previously-captured reference images containing the user's face and captured under specified lighting conditions. The comparison yields one or more calibration outputs that are applied to the one or more subject images to generate adjusted subject images, for example, images that have been white-balanced to remove color casts caused by the lighting conditions.

### BACKGROUND

Light sources may be characterized or described as having a “color temperature,” which commonly is stated in degrees kelvin. Color temperatures over 5,000K, for example, are referred to as “cooler colors” (bluish white) while lower temperatures are referred to as “warm” colors (yellowish white through red). The human eye is able to readily adapt to varying color temperatures. Cameras, however, lack such an innate ability to adapt, which can result in unrealistic or undesirable color casts depending on lighting conditions. For example, a photograph taken on a cloudy day (relatively cool temperature) can result in the photograph having a bluish cast.

White balancing is commonly employed in photography to normalize the incident light and remove unwanted color casts. Auto-white balancing algorithms may be employed to assess the color temperature of a scene and make appropriate adjustments to captured images. Color temperature may be estimated, for instance, by taking an average coloration of a scene, or by analyzing color of a selected reference object. These methods, however, can break down in certain settings. Another common option is to allow the user to manually specify the nature of the light source, e.g., candlelight, tungsten, sunrise/sunset, fluorescent, daylight, cloudy, etc. This method, however, requires explicit user input and introduces the potential for selecting the wrong setting. A further option is to introduce a “gray card” into the photographed scene as a reference object having a specifically known color and reflectance. The color reflected off of the gray card is then used to precisely assess the temperature of the light source illuminating the scene. Use of a gray card, however, can be time-consuming, inconvenient and burdensome, such that the vast majority of users never employ the method despite its accuracy.

### BRIEF DESCRIPTION OF THE DRAWINGS

FIG. 1 depicts a system and method for capturing subject images and calibration images, and then adjusting the subject images based on a comparison of the subject images with previously-captured reference images containing the face of a user.

FIG. 2 schematically depicts aspects of the system of FIG. 1.

FIG. 3 depicts a user capturing a reference image of the user's face for later comparison to one or more calibration images containing the user's face.

FIG. 4 depicts a user interface operable by a user to designate a lighting condition associated with a captured reference image.

FIG. 5 is a flow chart depicting an exemplary method for adjusting subject images based on a comparison between previously-captured reference images of a user's face and calibration images captured during the same capture session as the subject images and containing the user's face.

FIG. 6 depicts an exemplary computer system that may be used to implement and carry out various aspects of the image capture and processing operations described herein.

### DETAILED DESCRIPTION

The present description contemplates a photography system in which the user's face acts as a neutral reference object—similar to a gray card—to aid in estimating the color temperature of ambient lighting conditions. A specific example will now be described with reference to a smart phone having a front-facing camera (i.e., facing the user) and an opposing rear-facing camera.

In order for a user's face to function as an accurate reference object, the system uses stored example images containing the user's face, called “reference images,” to provide information with which to analyze the lighting conditions of newly captured images. The reference images are captured under lighting conditions specified by the user at the time of capture through a user interface, such as the one depicted in FIG. 4, allowing for the assignment of lighting condition categories such as candlelight, tungsten, sunrise/sunset, fluorescent, daylight, cloudy, etc. The reference images are compared against subsequently-captured images of the user's face (referred to as “calibration images”) to estimate the color temperature of the lighting conditions at the time of the subsequent capture. A greater number of reference images, captured in a variety of lighting conditions, can improve the accuracy of the color temperature estimation on the subsequently-captured calibration images of the user's face.

The user operates a camera application on their smart phone over an interval which will be referred to as a capture session. During the capture session, the rear-facing camera of the smart phone captures “subject images,” containing the intended target subject matter (e.g., a portrait, landscape scene, etc.), while the front-facing camera captures the calibration images, at least some of which contain the user's face. In this example, both the subject images and the calibration images are captured as real-time video, and the subject images are displayed to the user in real time on the front display of the smart phone, such that the display acts as a viewfinder that shows the user the content being captured by the rear-facing camera. Subject images may also be stored as captured still shots when the user activates a “shutter” control button on the face of the phone. As discussed below, one or more of the calibration images which contain the user's face can be compared to the reference images of the user's face in order to adjust the subject images being displayed on the smart phone screen (e.g., adjust white balance).

Facial recognition typically will be used in connection with the calibration images to identify specific calibration images containing the face of the user (the aiming of the front-facing camera can result in some of the calibration images not containing the face of the user). The matching images are then compared to the previously-captured reference images of the user's face in order to estimate the color temperature of the light incident upon the user's face during the calibration image capture. And since the calibration images were captured during the same capture session as the subject images, (e.g., at roughly the same time, such as within seconds or minutes of one another, and therefore presumably illuminated by the same light source), it can be assumed that the color temperature estimate is valid for the captured subject images. This color temperature estimate is then used to do a white balance correction on subject images captured during the capture session. At that point, the white balanced subject images are sent to the smart phone's display or stored in memory on the phone or externally on a server or other computer system.

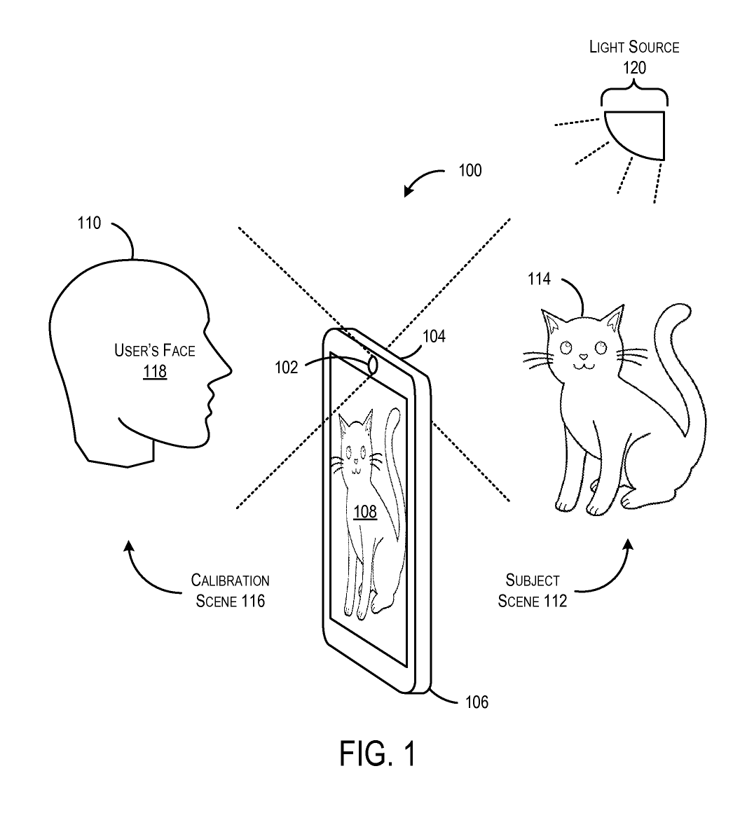

Turning to the figures, FIG. 1 depicts an image capture system 100 including two cameras 102 and 104, housed in a common enclosure 106, which may also include a display 108. Cameras 102 and 104 are situated within the housing so that they are differently-aimed, i.e., they point in different directions. In the depicted example, system 100 is a portable electronic device with front-facing camera 102 and rear-facing camera 104 aimed in opposite directions, where “front-facing” refers to the respective camera being aimed toward a user 110 of the device during normal operation.

Rear-facing camera 104, also referred to as a subject camera, captures a subject scene 112 including the content targeted by the user to be captured photographically. Subject scene 112 includes subject 114. Additionally, front-facing camera 102, also referred to as a calibration camera, captures a calibration scene 116 potentially including the face 118 of user 110 to be used as a reference object (e.g., to assist in white balancing or other adjustments). Further, subject 114 and the user's face 118 are exposed to common lighting conditions, i.e., they are both illuminated by the same light source 120. The common lighting conditions allow for the color temperature of the subject image, containing the subject, to be determined once the color temperature of the user's face, contained in the calibration image, is calculated. As described in more detail below, the cameras are operated during a capture session to capture calibration images of the calibration scene and subject images of the subject scene at the same time or relatively close in time (e.g., within a few seconds of one another). Although depicted here as having a smart phone form factor, it will be appreciated that image capture system 100 may take a variety of other forms (tablet computer, laptop, dedicated digital camera device, etc.) in which two differently-aimed cameras are employed.

During a capture session, subject camera 104 may be used in various ways to capture one or more subject images of the subject scene 112. The subject camera may capture subject images when triggered by the user, such as when a user activates a “shutter” button. The captured subject image may then be displayed on display 108 to show the user what has been captured. Alternatively the subject images may be captured automatically and continuously during the capture session in order to provide a real-time video representation of the subject scene on display 108, where the display may function as a viewfinder (i.e., showing the content being captured by the subject camera as a result of how it is aimed).

The subject and the user's face are illuminated by lighting conditions represented by light source 120, where the light source may be a candle, tungsten lamp, the sun, or any other source of light. As described above, the lighting conditions may have a color temperature caused by differing intensities of light in the visible spectrum, which, if not accounted for, could produce an undesirable color cast in captured subject images.

During the capture session in which the subject images are captured, the calibration camera 102 captures images of a calibration scene 116, which potentially contain the face 118 of user 110. Based on how the device is held, the captured calibration images may or may not contain the face of the user. For example, the user may hold the device above their head to capture the subject scene from a particular angle, such that the calibration camera at that moment is aimed away from the user's face, thereby resulting in capture of calibration images that do not contain the user's face. Accordingly, facial recognition mechanisms (e.g., software) may be used to identify which captured calibration images contain the user's face. Those images identified as containing the user's face are then stored and subsequently compared to the previously-captured reference images of the user's face to determine the color temperature of light source 120. The color temperature calculation is then used to control white balancing operations on the subject images.

The calibration scene is illuminated by the same light source that illuminates the subject, and the calibration scene and subject scene are therefore described herein as being subject to common lighting conditions. Capturing the face of the user in the calibration scene provides a reference object under common lighting conditions with subject images captured during the same capture session. The user's face functions as a known reference object, similar to a gray card, but without the inconvenience, extra steps and various other disadvantages associated with having to use a gray card.

In using the calibration images, as described above, facial recognition may be used to determine whether a given calibration image contains the face 118 of the user 110. One or more of the images that do contain the user's face are compared to previously-captured reference images also containing the user's face, each of which were captured under known lighting conditions (e.g., as specified by the user). The comparison allows the image capture system to estimate the color temperature of the calibration scene, which in turn can be used to infer the temperature of the light on the subject since the calibration and subject images were captured in the same capture session under common lighting conditions.

It will often be desirable to have multiple different previously-captured images of the user's face, as this can potentially improve the accuracy of operations that assess the character of the light incident upon the calibration scene and the subject scene (i.e., the color temperature of light source 120). Accuracy can be improved if multiple reference images are captured for a given color temperature (e.g., multiple images of the user's face under direct sunlight). Improvements may also be achieved via capture of the user's face under different specified lighting conditions. For example, the color temperature of a calibration image captured in 3000K lighting conditions may be more accurately estimated if the reference images included images captured in lighting conditions that are both above (>3000K) and below (<3000K) the color temperature of the calibration image. If the color temperature of the calibration image is higher than the highest reference image or lower than the lowest reference image, it still benefits from multiple reference images, as the relationship between the color temperature of lighting conditions and the user's face may be more accurately understood. The resulting color temperature estimate may be used to generate a white balance correction value to apply to the subject images.

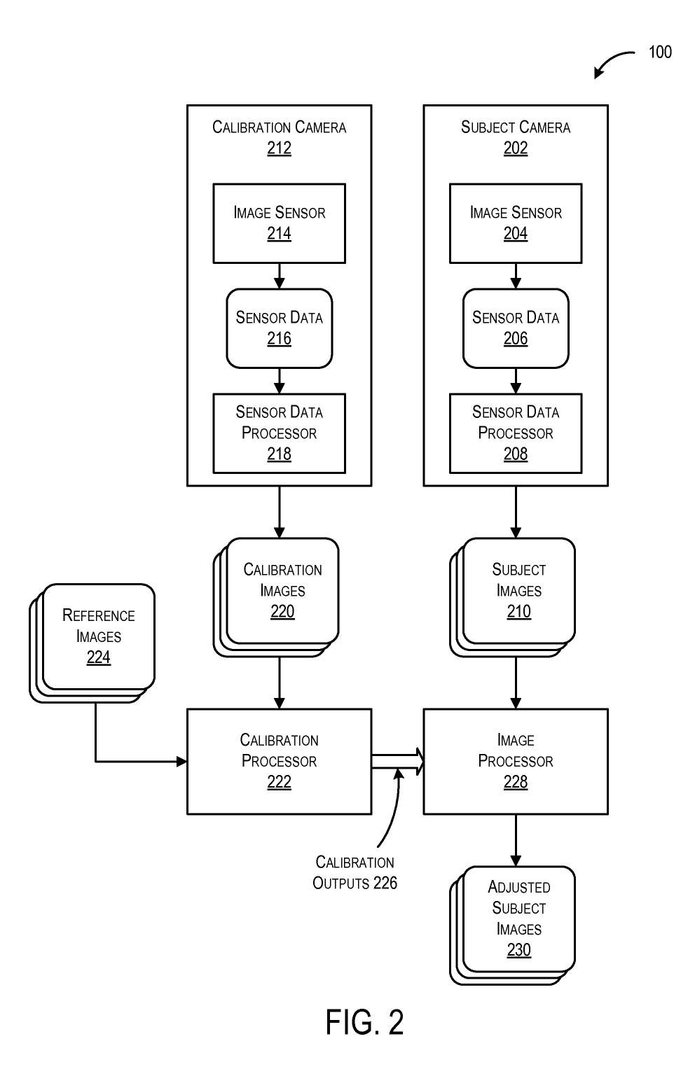

Again, the process of determining white balance correction values or other adjustments includes comparing the calibration images to previously-captured reference images. FIG. 2 depicts an implementation and further details of the image capture system 100 of FIG. 1 and an example of a process for adjusting captured subject images in order to account for the color temperature of the light illuminating the subject.

Subject camera 202 includes an image sensor 204, which outputs sensor data 206 based on light incident upon the image sensor 204. The sensor data is processed by sensor data processor 208 in order to generate subject images 210. The differently-aimed calibration camera 212 similarly includes an image sensor 214 which outputs sensor data 216. The sensor data from the subject camera is processed by sensor data processor 218 in order to yield calibration images 220. As previously described, the subject images include images of a subject (e.g., a portrait), while the calibration images potentially contain images of the user's face. The ability of the system to control white balance or other corrections is dependent upon at least some of the calibration images containing the user's face.

Calibration processor 222 is configured to receive calibration images 220 and reference images 224 and to perform processing operations which yield calibration outputs 226. In some implementations, the calibration processor performs facial recognition to determine whether a face is present in a given calibration image. It will be noted that any appropriate facial recognition methodology may be employed, including landmark extraction and texture analysis. Additionally, the calibration processor 222 is configured to compare those calibration images 220 determined to contain the user's face to reference images 224 also containing the user's face taken under user-specified lighting conditions. Based on the comparison, one or more calibration outputs 226 is generated, which may be a white balance adjustment value, and where if more than one is generated, the outputs may be generated simultaneously. The calibration outputs may vary dynamically as new calibration images are received at the calibration processor.

Calibration outputs 226 are sent to image processor 228, where the outputs are usable to adjust the one or more subject images 210. Specifically, image processing operations performed by image processor 228 on subject images 210 may be controlled based on the calibration outputs 226, thereby yielding adjusted subject images 230. It will be understood that existing algorithms or other suitable methods may also be used to control the image processing operations of the image processor. In implementations where the calibration outputs are white balance adjustment values, the color temperature of a given subject image is adjusted to a different temperature. Typically, the adjustment is performed to remove skewed color casts and thereby produce adjusted subject images that are more consistent with what is perceived with the human eye. Alternatively, white balance adjustment may be performed to achieve color casts that vary in some desired way from what is perceived by the human eye. In any case, the adjusted subject images may be saved to memory on the image capture system or other system and/or sent to the display to allow the user to view the subject scene in an adjusted state in the viewfinder. Still further, the calibration outputs may simply be associated with various subject images, in order to allow post-processing at a later time, for example on another computing system to which the subject images are transferred. The calibration processor itself may also be located on another system, i.e., separate from the camera system enclosure that contains the calibration camera 212 and subject camera 202.

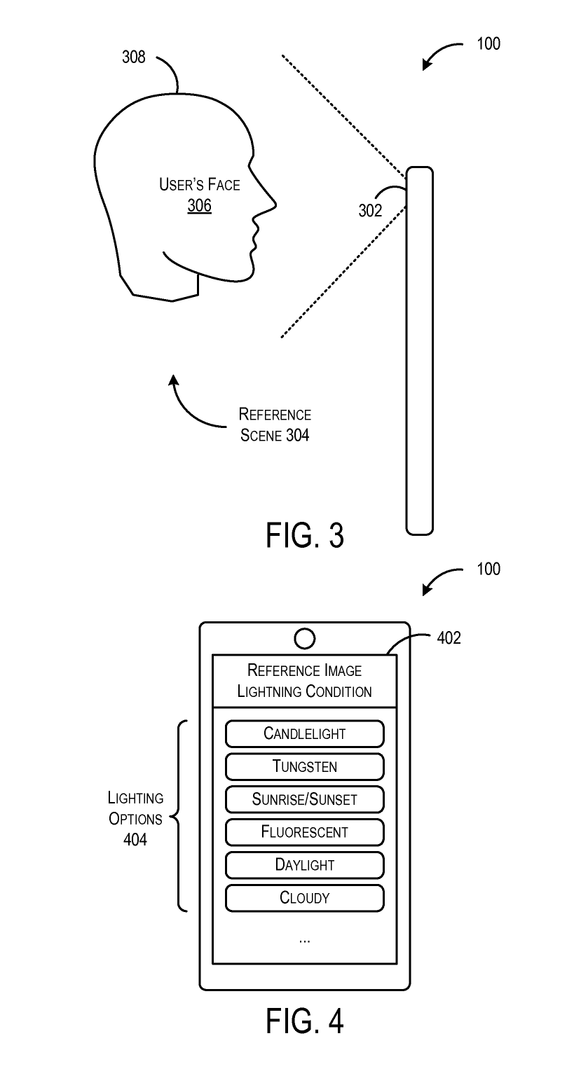

FIGS. 3 and 4 depict an example of capturing reference images and associating those reference images with specified lighting conditions. The reference images may be captured and associated with specified lighting conditions outside of a capture session. i.e., before the capture session in which calibration images are captured and compared to the reference images. FIG. 3 depicts the environment in which a reference image may be captured. Image capture system 100 is positioned so that reference camera 302 is aimed at reference scene 304. In the present example, reference camera 302 is the same camera that will be subsequently used to capture calibration images. It will be noted, however, that the reference images may be captured with a different camera, i.e., a photographic device other than that used to capture the subject images and calibration images discussed herein. Typically, however, it will often be desired to use the same camera to capture the reference images and calibration images, in order to avoid issues resulting from cameras having different characteristics (e.g., different optics, sensors, etc.).

Continuing with FIG. 3, camera 302 captures images of the reference scene 304, such that images containing the face 306 of user 308 are stored for later use. The display of image capture system 100 may act as a viewfinder for user 308, which may assist in keeping the user's face 306 in frame during a capture attempt. It will be noted that failure to identify the presence of the user's face 306 in a reference image with facial recognition may prompt a message stating such to be displayed.

FIG. 4 depicts a user interface 402 utilized to identify the lighting conditions of the environment of reference scene 304. Once the reference image has been captured, user 308 may be prompted by the image capture system to input an approximation of the lighting conditions of the reference scene through user interface 402. The example user interface 402 allows user 308 to select which of lighting options 404 applies to a given captured reference image. While the lighting options include candlelight, tungsten, sunrise/sunset, fluorescent, daylight and cloudy, there are other commonly used options available, such as incandescent, noon sunlight, electronic flash and shade. Any appropriate lighting specification may be employed. Furthermore, there may be options for mixed lighting for cases where the reference scene has multiple types of light sources. In the cases where the image capture system 100 is a mobile device, such as a smart phone or a tablet, typically user 308 would select the appropriate lighting condition through a touch screen interface.

Identifying the approximate color temperature of the reference scene 304 as captured in the reference images provides a basis by which calibration images may be analyzed to determine the color temperature of a capture session. It will often be desirable to capture multiple different reference images in order to better and more accurately estimate the color temperature of subsequently-captured calibration images. For example, comparing a calibration image captured under fluorescent lighting to a single reference image captured in clear daylight may provide the correct color temperature; however, a set of reference images captured in candlelight, under tungsten lamps, in clear daylight and during a cloudy day would be likely to yield a more accurate assessment. Ideally, prior to a given capture session, multiple reference images from each of the lighting options 404 would be available for comparison. Multiple reference images may also improve the facial recognition system used to identify which images contain the user's face.

The identified reference images may be stored locally or externally. During a given capture session, the stored reference images may be fed to the image capture system 100 in order to dynamically adjust the viewfinder content being displayed on the display—i.e., the video stream of images from a camera showing what the camera is currently aimed at. In such a case, dynamic white balancing would allow a user to capture subject images in a capture session without being aware of the presence of undesirable color casts from the lighting conditions. Alternatively, the amount of white balancing being performed on the subject images displayed in the viewfinder may be provided graphically or numerically to the user, where the user may be given the option of applying an offset to the correction value to achieve a specific visual effect. For example, the user may desire a subject image with an intentionally unrealistic color cast, with the light appearing warmer or cooler than it would to the human eye.

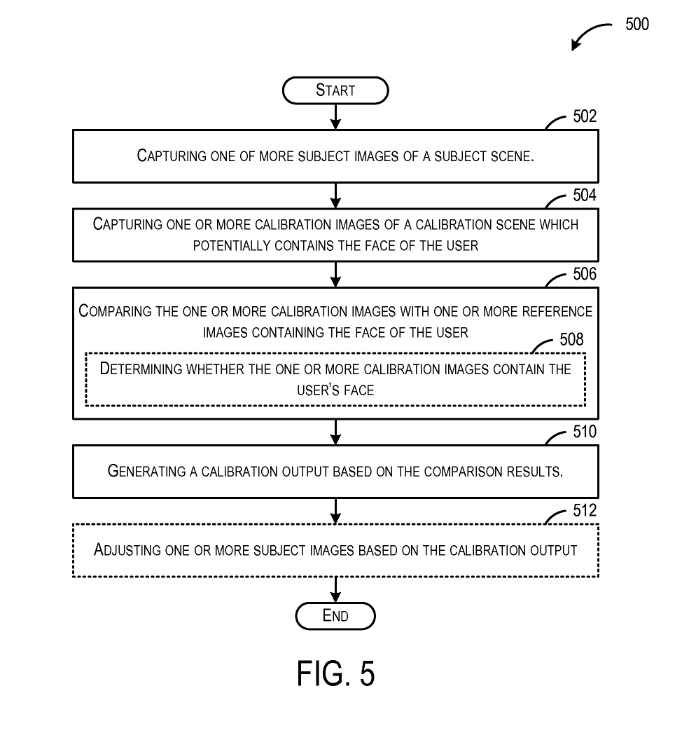

Turning now to FIG. 5, the figure depicts an exemplary method 500 for capturing and processing images. Method 500 may be carried out in connection with the exemplary systems/devices of FIGS. 1-4, though a wide range of alternate configurations are possible. As shown at 502, the method includes capturing one or more subject images of a subject scene. Continuous video or still shots may be captured. In the event of a still shot, the image capture system may respond to a request from the user, in the form of an activated shutter button, to capture the still. At 504 the method includes capturing one or more calibration images of a calibration scene which potentially contain the face of the user. As with the subject images, the calibration images may be continuous video or discrete still shots.

Subsequently, at 506 the method includes comparing the one or more calibration images with one or more reference images containing the face of the user. The method may include, at 508, determining whether the one or more calibration images contain the user's face. Facial recognition would be performed in such a case to determine whether calibration images are suitable for comparison to the reference images (i.e., whether they contain the user's face). Such a process may also include identifying the user from more than one user in order to retrieve the corresponding reference images. The comparison may involve analyzing the lighting conditions on the user's face in a given calibration image—i.e., identified as containing the user's face—and comparing the analysis to a reference image with a specified lighting condition.

The comparison of calibration images and reference images yields one or more calibration outputs, as shown that the generating step 510. Finally, at 512, the method may include adjusting one or more subject images based on the calibration output. The adjusted subject images may, at this point, be displayed on the display of the image capture system to act as a viewfinder during a capture session or stored in a data holding subsystem, locally or externally. As described above, controlling white balancing is one option for generating adjusted images, though other types of adjustments may be possible.

In some cases, the image capture system will include a flash that adds an additional component to the lighting conditions captured in the subject images. Flash lighting often will have a different color intensity profile than the incident light, and mixing the flash with the incident light can add complexity to white balance adjustment/correction. The flash, however, is a known lighting condition and can be accounted for in the adjustments described above with reference to FIGS. 1-5. Specifically, the above methods may be used to first calculate the temperature of light incident upon the user's face, and then make an estimate of how such temperature would be affected by the flash component. In the context of FIG. 2, calibration outputs 226 would be based on both the flash contribution and the reference/calibration image comparison.

It will be noted that while the subject/calibration cameras are contained in the same enclosure, the calibration processor and image processor may be externally located (e.g., laptop, desktop, remote server system, or elsewhere off-camera), separately or together. As such, the image correction process may occur after the capture session is ended, which may take place when the image capture system is coupled to the calibration processor and image processor—e.g., connecting a tablet containing subject images and calibration images from the same capture session to a laptop containing the calibration processor and image processor. Additionally, the image correction process may occur during the capture session through remote data transfer. For example, a smart phone may upload one or more subject images to a web server to perform the correction.

It will be noted that the image capture system may be configured to handle multiple users such that the calibration images may be used to identify a user from a plurality of users. Thus, only reference images corresponding to the identified user would be used for comparison to the calibration images. Further, the process by which a user captures reference images might include a step whereby the user is identified so that the reference image may be retrieved for calibration processes involving the same user.

While the above examples describe a common enclosure in the context of modern smart phones and mobile devices, it will be noted that the common enclosure may include detachable and reattachable portions that may include either the subject camera or the calibration camera. As such, the subject camera and calibration camera may not necessarily be aimed in opposite directions.

While the example involves white balance correction, it will be understood that other forms of correction, in full or in part, are possible. The possible corrections include correcting color balance, exposure compensation, contrast, and any other suitable image characteristic correction.

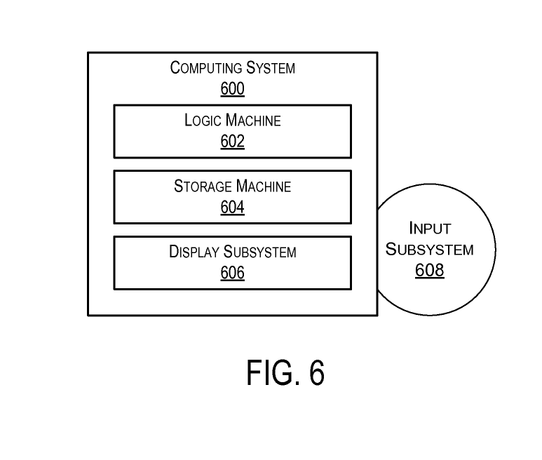

FIG. 6 schematically shows a non-limiting embodiment of a computing system 600 that can enact one or more of the methods and processes described above. Such a computing system may be implemented within the common enclosure shown in FIG. 1, and may also be implemented elsewhere, e.g., to perform off-device image processing operations. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices. Functionality described herein may be implemented variously in software, hardware, or combinations of software and hardware. For example, the cameras of FIG. 2 may have a hardware pipeline that performs some image processing operations, while other aspects of the described operation are performed in software, such as the described white balancing operations.

Computing system 600 includes a logic machine 602 and a storage machine 604. Computing system 600 may optionally include a display subsystem 606, input subsystem 608, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. For example, such executable instructions may be implemented as facial recognition software, identifying the presence of a user's face in a wide range of lighting conditions. As an additional example, such executable instructions may be implemented to perform a white balance correction process, usable to edit digital images based on calibration outputs such as those shown in FIG. 2. In any case, when instructions execute or other processes/methods are performed, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. For example, such executable files may be configured to perform the tasks described above as pertaining to the calibration processor and image processor. Specifically, the executable files may be configured to analyze images to determine the presence of a face, quantify light condition characteristics, generate image calibration outputs, and edit digital images based on correction values.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. For example, display subsystem 606 may be a front facing display on a smartphone. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

It will be appreciated that methods described herein are provided for illustrative purposes only and are not intended to be limiting. Accordingly, it will be appreciated that in some embodiments the methods described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware in addition to or instead of the specific examples described herein. This disclosure also includes all novel and non-obvious combinations and sub-combinations of the above systems and methods, and any and all equivalents thereof.

1. An image capture system, comprising:
a subject camera configured to capture one or more subject images of a subject scene;
a calibration camera in a common enclosure with the subject camera, the calibration camera being aimed differently than the subject camera and configured to capture one or more calibration images of a calibration scene which potentially contains the face of a user, where the one or more subject images and the one or more calibration images are captured together during a capture session and under common lighting conditions; and
a calibration processor configured to generate a calibration output based on a comparison of at least some of the one or more calibration images with one or more reference images containing the face of the user, the calibration output being useable to adjust the one or more subject images.

2. The image capture system of claim 1, further comprising an image processor that adjusts the one or more subject images based on the calibration output of the calibration processor.

3. The image capture system of claim 2, where the image processor is configured to adjust a white balance of the one or more subject images based on the calibration output.

4. The image capture system of claim 1, where the subject camera is a rear-facing camera of a portable electronic device and the calibration camera is a forward-facing camera of the portable electronic device.

5. The image capture system of claim 1, further comprising a user interface configured to allow the user to specify lighting conditions associated with the one or more reference images containing the user's face, where the calibration processor uses such specified lighting conditions to infer a color temperature of the common lighting conditions associated with the capture session.

6. The image capture system of claim 1, where the one or more reference images include multiple reference images of the user's face taken under different lighting conditions.

7. The image capture system of claim 1, where the one or more reference images include multiple reference images of the user's face taken under similar lighting conditions.

8. The image capture system of claim 1, where the calibration processor is configured to detect whether the one or more calibration images contain the face of the user.

9. The image capture system of claim 1, where the calibration camera is configured to capture the one or more calibration images by taking continuous video of the calibration scene.

10. A method of capturing and processing images, comprising:
with a subject camera, capturing one or more subject images of a subject scene;
with a calibration camera housed in a common enclosure with and aimed differently than the subject camera, capturing one or more calibration images of a calibration scene which potentially contains the face of a user, where capturing the calibration images and subject images occurs during a capture session and under common lighting conditions;
comparing at least some of the one or more calibration images with one or more reference images containing the face of the user; and
generating a calibration output based on the comparing, such calibration output being useable to adjust the one or more subject images.

11. The method of claim 10, further comprising adjusting the one or more subject images based on the calibration output.

12. The method of claim 11, where adjusting the one or more subject images includes adjusting a white balance of the one or more subject images based on the calibration output.

13. The method of claim 10, further comprising specifying lighting conditions associated with the one or more reference images containing the user's face, where the specified lighting conditions are used to infer a color temperature of the common lighting conditions associated with the capture session.

14. The method of claim 10, where the one or more reference images include multiple reference images of the user's face taken under different lighting conditions.

15. The method of claim 10, where the one or more reference images include multiple reference images of the user's face taken under similar lighting conditions.

16. The method of claim 10, further comprising detecting which of the calibration images contain the face of the user.

17. An image capture system, comprising:
a subject camera configured to capture one or more subject images of a subject scene;
a calibration camera in a common enclosure with the subject camera, the calibration camera being aimed differently than the subject camera and configured to capture one or more calibration images of a calibration scene which potentially contains the face of a user, where the one or more subject images and the one or more calibration images are captured together during a capture session and under common lighting conditions;
a calibration processor configured to (i) detect whether the one or more calibration images contain the user's face, (ii) compare one or more calibration images containing the user's face with one or more reference images containing the user's face, and (iii) generate a calibration output based on the comparison of (ii); and
an image processor configured to adjust a white balance of the one or more subject images based on the calibration output.

18. The image capture system of claim 17, where the subject camera is a rear-facing camera of a portable electronic device and the calibration camera is a forward-facing camera of the portable electronic device.

19. The image capture system of claim 17, where the calibration camera is configured to capture the one or more calibration images by taking continuous video of the calibration scene.

20. The image capture system of claim 17, where the one or more reference images include multiple reference images of the user's face taken under different known lighting conditions.
